(19) United States
(12) Patent Application Publication
(10) Pub. No.: US 2017/0132785 A1
(43) Pub. Date: May 11, 2017

(54) METHOD AND SYSTEM FOR EVALUATING THE QUALITY OF A SURGICAL PROCEDURE FROM IN-VIVO VIDEO

(71) Applicants: Xerox Corporation, Norwalk, CT (US); University of Rochester, Rochester, NY (US)

(72) Inventors: Safwan R. Wshah, Webster, NY (US); Ahmed E. Ghazi, Rochester, NY (US); Raja Bala, Pittsford, NY (US); Devansh Arpit, Buffalo, NY (US)

(21) Appl. No.: 15/138,494

(22) Filed: Apr. 26, 2016

Related U.S. Application Data
(60) Provisional application No. 62/252,915, filed on Nov. 9, 2015.

(51) Int. Cl. G06T 7/00; G06N 3/08; G06T 7/40

(52) U.S. Cl. CPC G06T 7/0012; G06T 7/408; G06N 3/08; G06T 2207/20081; G06T 2207/10016

(57) ABSTRACT

The quality of surgeries in captured videos is modeled in a learning network. For this task, a dataset of surgical video is given with a corresponding set of scores that are labeled by reviewers, to learn a model for quality assessment of surgical procedures. A learned model is then used to automatically assess quality of a surgical procedure, which omits the need for professional experts to manually inspect such videos. The quality assessment of surgical procedures can be performed off-line or in real-time as the surgical procedure is being performed. Surgical actions in surgical procedures are also localized in space and time to provide a feedback to the surgeon as to which action can be improved.

### RELATED APPLICATIONS AND CLAIM OF PRIORITY

This patent document claims priority to U.S. provisional patent application No. 62/252,915, filed Nov. 9, 2015. The disclosure of the priority application is fully incorporated into this document by reference.

### BACKGROUND

This disclosure relates to methods and systems for evaluating the quality of a surgical procedure using in-vivo video capturing and image processing.

Videos captured in-vivo during a surgical procedure are often analyzed after the procedure is complete in order to evaluate the quality of the procedure, identify errors that have taken place, assess the expertise and skill level of the surgeon, and/or to provide coaching and feedback to students of surgery. For example, minimally invasive surgery (MIS) is playing an increasing role in surgery, particularly in surgical, urological and gynecological procedures. When compared to traditional open surgery, MIS offers the advantages of better visibility and access to internal tissue, less trauma to tissue, and better comfort and reduced fatigue on the part of the surgeon.

Procedures such as these are easily captured by the cameras and can be stored and reviewed offline. For example, after a trainee performs a procedure, it is common practice to review the videos with a surgeon, and provide feedback on the quality of the surgery and opportunities for improvement. However, this is a time consuming process. The surgeon has to spend many hours reviewing the video, in order to find the few critical segments that will convey the quality of the procedure. Further, in order for a surgeon to give instant real-time feedback while a trainee is performing a procedure, the surgeon has to be present at the surgery all time. This requires many hours of laborious inspection by surgeons.

This document describes devices and methods that are intended to address issues discussed above and/or other issues.

### SUMMARY

The embodiments disclose a method and system for automatically assessing quality of a surgical procedure. Various embodiments use an imaging device to capture and/or a processor to receive a sequence of digital image frames of a first surgical procedure, and save one or more clips of the sequence of digital image frames to a data storage facility, each clip corresponding to a surgical action. For each clip, a dual-stream processing is performed on the image frames of the clip, to identify a spatial stream and a temporal stream. The spatial stream and temporal stream are processed with a learned model for surgical quality assessment to automatically generate an assessment score indicative of the quality of the surgical procedure. Optionally, before the dual stream processing, the system may sub-sample the sequence of image frames for the one or more clips such that the number of image frames contained in each sub-sampled clip is reduced.

In one embodiment, the learned model can be learned using a set of training data containing in-vivo video of surgical procedures of the same type of surgical procedures for assessment, along with corresponding quality scores that are labelled by surgeons who have reviewed the surgical video. The surgical video in the training data set is segmented to one or more training clips so that each training clip corresponds to a surgical action. For each training clip, a dual-stream processing is performed on the image frames of the clip, to identify a spatial stream and a temporal stream. The spatial stream and temporal stream may be used, together with the quality scores labelled by surgeons, to automatically learn features needed to train the learned model for surgical quality assessment. The learned model can be re-learned progressively as new training dataset becomes available.

In one embodiment, the learning network for learning the model is a convolutional neural network, which comprises a plurality of convolutional layers and one or more fully connected layers. The spatial stream is obtained from image frames in the clip and the temporal stream is obtained from optical flow image frames of the original frames in the clip. In one embodiment, the learned model can be pre-trained using a standard set of action recognition dataset to obtain initial parameters for the learned model.

The quality assessment of surgical procedures can be performed offline for professional training and evaluation purposes. In another embodiment, the quality assessment can be performed in real-time while the surgeon is performing the surgery, to provide an instant feedback as to how the surgery is perform and where it needs to be improved.

### BRIEF DESCRIPTION OF THE DRAWINGS

FIG. 1 shows an example of a surgical procedure quality assessment system according to one embodiment.

FIG. 2 depicts an example of method for assessing the quality of a surgical procedure using the system in one embodiment.

FIG. 3 depicts an example of learning model architecture.

FIG. 4 depicts an aspect of a learning model according to one embodiment.

FIG. 5 depicts an aspect of training a learned model according to one embodiment.

FIG. 6 depicts various embodiments of one or more electronic devices for implementing the various methods and processes described herein.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, any word in singular form, along with the singular forms “a,” “an” and “the,” include the plural reference unless the context clearly dictates otherwise. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to.”

The terms “memory,” “computer-readable medium” and “data store” each refer to a non-transitory device on which computer-readable data, programming instructions or both are stored. Unless the context specifically states that a single device is required or that multiple devices are required, the terms “memory,” “computer-readable medium” and “data store” include both the singular and plural embodiments, as well as portions of such devices such as memory sectors.

Each of the terms “video capture module,” “imaging device,” “imaging sensing device” or “imaging sensor” refers to a software application and/or the image sensing hardware of an electronic device that is capable of optically viewing a scene and converting an interpretation of that scene into electronic signals so that the interpretation is saved to a digital video file comprising a series of images.

Each of the terms “deep learning,” “convolutional neural network,” “learning network,” “learned model” and “convolutional layer” refers to corresponding terms within the field of machine learning and neural network.

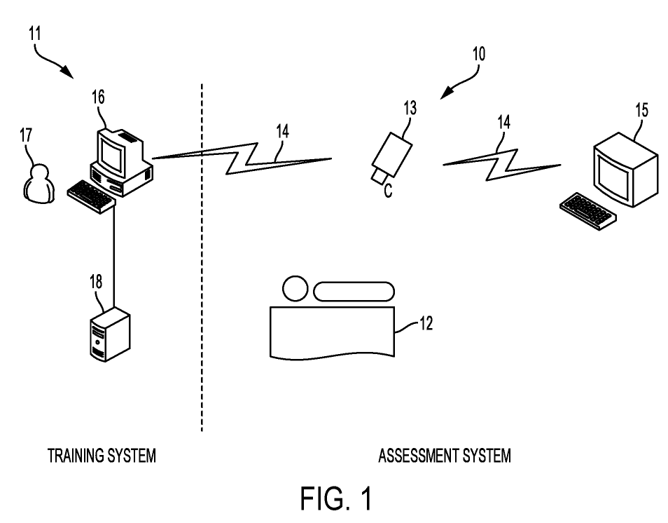

With reference to FIG. 1, a surgical procedure quality assessment system 10 may comprise an image capturing device 13 that is positioned over a surgical table 12 or used as a component of a surgical device for capturing sequence of image frames of a surgical procedure. The evaluation system 15 has a processor and is in communication with the imaging capturing device 13 through a communication link 14 to receive captured images. The evaluation system 15 processes the captured images and uses a learned model to automatically assess the quality of the surgical procedure. In one embodiment, a training system 11 may comprise a data storage 18 that stores surgical procedure videos to be used for training the learned model, a processor 16 for performing the training, a display for displaying a training video of surgical procedures to a surgeon (or reviewer) 17, and an input device for receiving quality assessment scores from the surgeon who is viewing the training video. In one embodiment, the input device is a keypad coupled to the processor that allows the surgeon to enter numerical scores. In another embodiment, the input device is a computer keyboard and/or mouse coupled to the processor 16, which allows the surgeon to enter assessment scores via a software application, such as a control panel or graphical user interface.

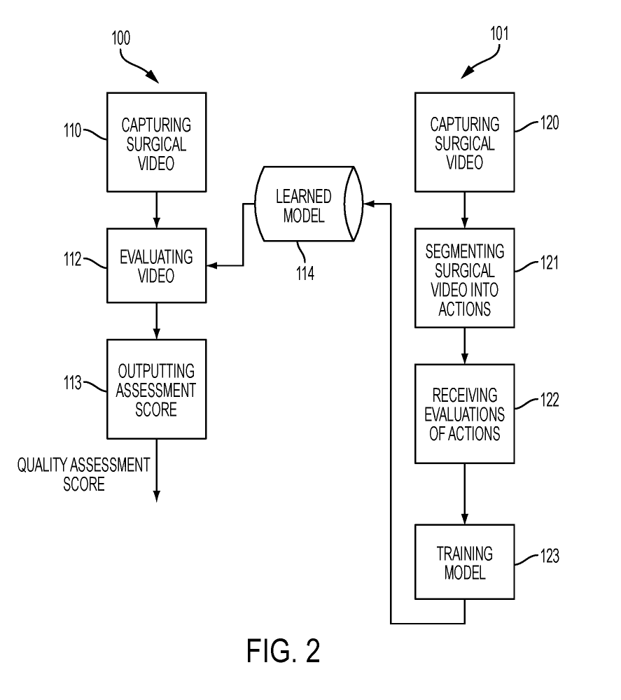

With reference to FIG. 2, methods for assessing quality of surgical procedures are described. In an assessing mode 100, the assessment system may use an image capturing device to capture a digital image stream that makes up a video of a surgical procedure 110 and apply a learned model 114 to evaluate the digital video and generate a quality assessment score for the video 112, and output the assessment score 113. The captured surgical video comprises one or more clips. Each clip may correspond to a pre-identified surgical action, such as stitching. The system, without human or surgeon's intervention, generates and outputs one or more scores of one or more actions in the videos, indicative of the quality of each surgical action. Therefore, the surgical procedure quality assessment system can evaluate the quality of a surgical procedure that involves several surgical actions.

An automatic segmentation may be employed to evaluate a surgical procedure off-line by segmenting a sequence of digital image frames of the surgical video into a set of clips, each clip representing a surgical action. An assessment score is obtained for each of the clips and an overall assessment score can be obtained from combining the assessment scores of one or more clips. Alternatively and/or additionally, the assessment system 10 (in FIG. 1) could evaluate the quality of a surgical procedure while the doctor is performing the surgery. Segmentation of surgical video may be performed in real-time while the surgical video is captured. Well-known video segmentation techniques can be used, for example, by detecting scene change or key frame change, to identify the change of surgical actions, for example, from cutting to stitching. At the end of each detected surgical action, the system can generate an assessment score for the detected surgical action and output it to the doctor as real-time feedback. Before the dual stream processing, the system may sub-sample the sequence of image frames in any of the clips such that the number of image frames contained in the clip is reduced.

Returning to FIG. 2, in training mode 101, the training system can be employed to train the learned model 114, for which a sequence of image frames of a training surgical procedure are captured 120 by an imaging capturing device. These image frames are segmented 121, by a processing device, into a plurality of clips, each clip corresponding to a surgical action. For each surgical action, a surgeon can manually view the clip and give an assessment score indicative of the quality of the surgical action. In one embodiment, the processing device executes machine readable instructions to cause the processing device to display the surgical action video to the surgeon and prompt the surgeon to give an assessment score at the end of each surgical action. The assessment score may be binary, for example, the surgeon may rate the quality of the surgery “Good” or “Bad.” In another embodiment, the surgeon may give a finer scale score based on various measures of quality. For example, as the examples show below, for a stitching procedure, a surgeon looks at several quality measurements associated with the procedure, such as the direction, position, etc., and give a score in the range of [−3, 3], with −3 (or +++B) being poorest quality and 3 (or +++G) being highest quality. Alternatively and/or additionally, the evaluations can be modeled to existing, validated objective metrics as OSATS (Objective Structured Assessment of Technical Skills) and GEARS (Global Evaluative Assessment of Robotic Skills).

The example data included in Table 1 below shows an expert evaluation for a sequence of surgical actions in a stitching procedure. B stands for “bad” and “G” stands for “good.”

TABLE 1

| Bladder | | Urethra | |
|---|---|---|---|
| 1 | B | 3 | +++B (position, grasp tissue, pull |
| | | | out) |
| 2 | +++B (position, | 4 | +++B (direction, depth, pull out, rip |
| | direction, pull out) | | tissue) |
| 5 | +++B (grasp tissue, | 6 | G |
| | camera not centralized, | | |
| | pull out) | | |
| 7 | +++B (grasp tissue, good | 9 | ++B (direction, pull out) |
| | dir and pull out) | | |
| 8 | ++B (direction, pull out) | 11 | ++B (grasp tissue, needle direction) |
| 10 | ++B (direction, pull out) | 13 | ++B (grasp tissue, direction) |
| 12 | ++B (grasp tissue, pull | 15 | +++B (direction, position, pull out, |
| | out) | | rip tissue) |
| 14 | ++B (grasp tissue, | 17 | ++B (position, pull out) |
| | instrument collision) | | |
| 16 | ++B (grasp tissue, | 19 | G |
| | position, pull out) | | |
| 18 | ++B (grasp tissue, needle | 21 | G |
| | direction) | | |
| 20 | ++B (position, pull out) | 23 | +B (pull out) |

When the learning/training system receives evaluation scores of training video from the surgeon 122, it trains the learned model from the training video 123 and generates the learned model 114. The training of the learned model can be repeated for any new training data with any new training data.

Various learning frameworks can be employed to learn the learned model 123. In one embodiment, a deep learning framework could be used. Deep learning is a class of machine learning techniques that learn multiple levels of representation in order to model complex relationships among data. Higher-level features are defined in terms of lower-level ones, and such a hierarchy of features is called a deep architecture. The key idea behind these algorithms is to automatically discover the underlying patterns for any given data, or in other words, automatic representation learning. Thus deep learning algorithms omit the need to design hand-crafted features and thus find the best representation to score the quality in surgical videos automatically from the provided data. As would be apparent to one ordinarily skilled in the art, other machine learning techniques can be used to train the learned model.

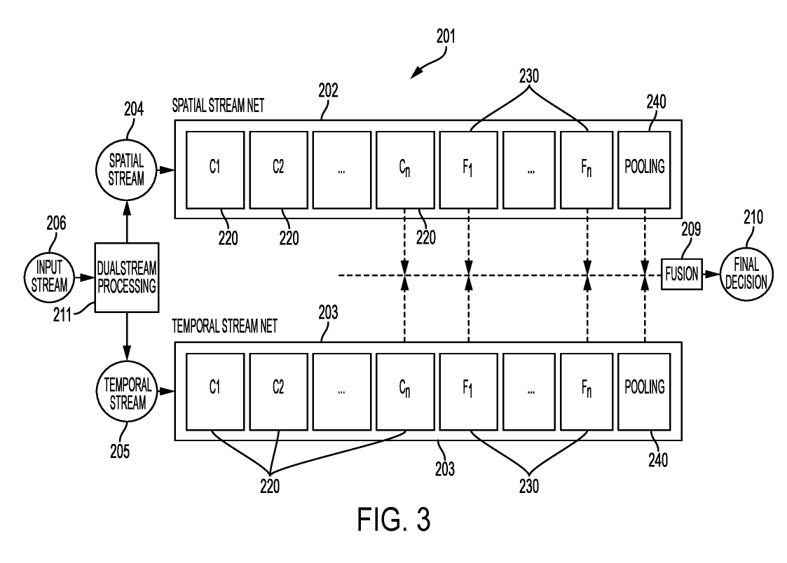

With reference to FIG. 3, a non-limiting example of a deep learning framework using a convolutional neural network 201 for evaluating a clip (i.e., a sequence of digital image frames) depicting one or more surgical procedures using in-vivo video is further explained. In one embodiment, a two-stream convolutional neural network could be used, i.e. the learned model may comprise a spatial stream net 202, which models the appearance variation in the input, and a temporal stream net 203, which models motion information in the input. The intuition behind using separate streams for appearance and motion is to imitate the human visual cortex where the dorsal stream performs object recognition while the ventral stream recognizes motion.

In constructing the learned model, both spatial and temporal stream nets may have similar architectures as they both can comprise a plurality of convolutional layers 220. Each of the convolutional layers has a number of filters F of certain size N, i.e. N×N×F, where N may be a number that is usually less than 15 and F is the number of features that could be a number that is usually less than 1024. In one example, both spatial and temporal stream nets could each have 5 convolutional layers 220, each with 11×11×96, 5×5×256, 3×3×384, 3×3×384, 3×3×512, respectively. In constructing the convolutional layers, in one embodiment, the stride for the convolutional layer can be a number of 8, such as 1 or 2. The pool can be P×P, for example, a number less than 8 such as 4 or 2. In one example, a stride of 2 could be used for the first two layers and 1 for the rest, and a pooling of size 2×2 for the first, second and fifth layer and no pooling for other layers.

In one embodiment, both spatial and temporal stream nets may both comprise one or more fully connected layers 230, each fully connected layer connects all neurons from the previous layer to every single neuron it has. Each fully connected layer can have a certain number of units, and the size of the full connected layer can be various and typically has the value of 4096, 2048, 1024 512 or less. In one example, two fully connected layers could be used and each could have 4096 units.

The convolutional neural network may also comprise an activation function that increases the nonlinear properties of the decision function and of the overall network. In one embodiment, a Rectified Linear Units (ReLU) is used for activation function. In another embodiment, a tanh function can also be used for activation function. The convolutional neural network may also comprise a pooling layer 240 to reduce variance. In one embodiment, softmax can be used as a pooling layer for all layers for binary quality assessment (good or bad) or tanh activation in case of fine score is used (−3 to 3) working as regression. To regularize the convolutional neural network, a dropout method could also be used to reduce over-fitting of fully connected layers and improve the speed of training. In one embodiment, a dropout of 0.5 on the fully connected layer weights and weight decay (0.0005) on the weight vectors could be used. For learning rate of the convolutional neural network, an initial value of 0.01 could be used and then reduced it to one-tenth every 4000 iterations and end the training after 12000 iterations.

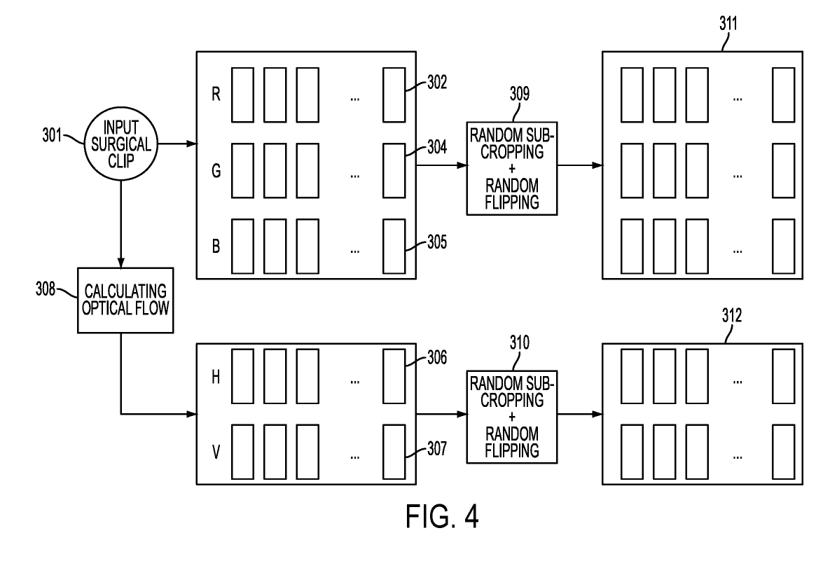

To utilize the learning framework, such as the convolutional neural network aforementioned, a dual-stream processing 211 is performed on the input video stream 206 to identify a spatial stream 204 and a temporal stream 205. The dual-stream processing 211 is further explained as below, with reference to FIG. 4. In one embodiment, the input spatial stream is formed by three channels of the surgical action video 301, each channel corresponding to a sequence of image frames of each primary color in a color model space, e.g. the RGB model. For each channel, such as the R (red) channel, the sequence of image frames in the R channel of the surgical video 302 is processed by a random sub-cropping and random flipping 309 for each of the frames in the sequence, for increasing the variance in the data. Various frame size can be used for sub-cropping, for example, a frame size of 224×224 can be used. Flipping can also be performed in different ways. For example, flipping can be performed horizontally or vertically. The processed sequence of image frames then forms part of the spatial stream 311.

Same processing could be performed for the other channels G (green) 304 and B (blue) 305 as for R channel, to form a three-channel spatial stream 311, each representing R, G and B. The resulting matrix for the spatial stream will have the dimension of 3×w×h, where w and h are width and height of the image frames, respectively. In another embodiment, other three-value or four-value color space model such as: (red-green-blue (RGB); hue, saturation and value (HSV), CIELAB; cyan, magenta and yellow (CMY); or cyan, magenta, yellow and key (CMYK) can also be used.

In dual-stream processing, according to one aspect, the input temporal stream is formed by computing dense optical flow 308 from consecutive frames in the surgical video. In one embodiment, optical flow image frames are obtained from the sequence of image frames in the surgical video 301 for both horizontal and vertical directions, to form a two-channel motion stream, one channel for horizontal optical flow 306 and the other for vertical optical flow 307. Optical flow captures a very basic form of motion (temporal) information from any given pair of images. It calculates a two dimensional motion field (horizontal and vertical) for every pixel. Thus, the result is a two channel motion map for a given pair of images. In another embodiment, optical flow fields from multiple consecutive image frames could be stacked to provide sufficient motion information. Suppose L such optical flow frames from images of dimension {3×w×h} are stacked, where w and h are width and height respectively, 3 denotes three channels in an RGB image, then the resulting matrix would be of dimensions {2L×w×h}, where L could be 1 or larger. As shown in FIG. 4, the processing of random sub-cropping and random flipping 310 can be performed on each channel of the optical flow (e.g. horizontal 306 or vertical 307), to generate the temporal stream 312. The forming of input spatial streams and input temperate streams applies to both training of learned model (training mode) and assessing quality of surgical videos (assessing mode).

With further reference to FIG. 4, in forming the spatial stream, a pre-processing could be used before the processing 309 is performed. For example, each of the image frames in the sequence of image frames for R channel of the surgical video 302 is subtracted by a mean image that is obtained from all or at least a majority portion of the image frames in the sequence. Same pre-processing could be performed for the other channels G 304 and B 305 as for R channel. As would be apparent to one ordinarily skilled in the art, other pre-processing techniques could also be used.

The dual-stream processing applies to both training and assessment. Returning to FIG. 3, in assessing mode, once the spatial stream 204 and temporal stream 205 are identified from the sequence of image frames in the training video of surgical procedures, they are processed by the spatial stream net 202 and temporal stream net 203 of the learned model, respectively, to produce a fused assessment score 210 that is indicative of quality of the surgical procedure. The system then output the assessment score. In one embodiment, in assessing mode, the sequence of image frames in a clip is sampled uniformly to increase the processing speed, which is particularly important for real-time quality assessment of surgical procedures. For example, for every test video, 25 frames can be uniformly samples from the input sequence of image frames.

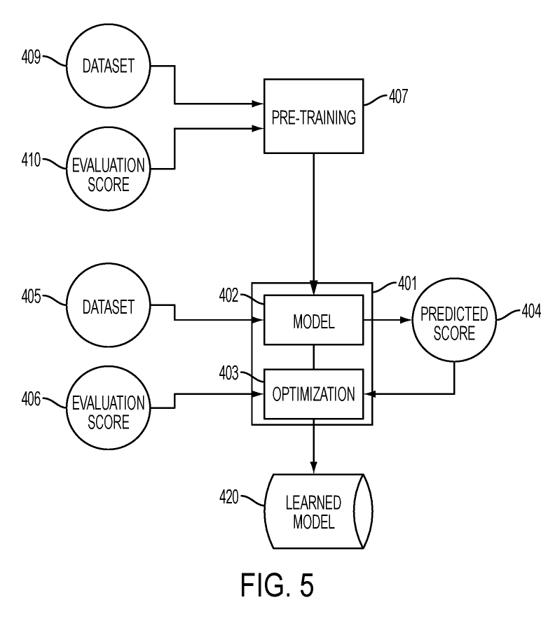

With reference to FIG. 5, the training of the learned model is further illustrated. The training of the learned model 401 takes the training data set 405 and generate a predicted score 404. The learned model is further optimized 403 by comparing the predicted score 404 with the received evaluation score 406 from the surgeon. In one embodiment, an evaluation metric is used for evaluating the prediction generated by the learning framework as well as measuring the cost of training. In one embodiment, the evaluation metric may use a regression framework with least squares cost. In another embodiment, a rank correlation may be used for computing the similarity of predicted scores with ground truth. For example, a rank correlation can vary between −1 and +1. While the former implies negative correlation, the latter implies perfect correlation between the two sets of scores. A value of zero on the other hand implies no correlation between the two sets of scores. These evaluation metric schemes could be advantageous over classification-like framework, which is limited to a fixed number of classifications.

Other cost functions may be used as would be apparent to one ordinarily skilled in the art. In one embodiment, the optimization could use stochastic gradient descent with a pre-determined determined batch and a momentum. For example, the batch size could be 128 and the momentum could be about 0.9.

Alternatively and/or additionally, a pre-training 407 can be used to obtain initial model weights (parameters), which may lead to an improvement in performance of the final task. Because the purpose of the pre-training is to help obtain better initial weights (parameters), the training dataset 409 for pre-training does not always have to be of the same type of surgical video under assessment. For example, in one embodiment, for building a learned model for assessing quality of surgical procedures, a pre-training dataset such as UCF-101 (action recognition dataset available publicly) can be used.

In calculating the predicted scores, for each clip that corresponds to a surgical action, each frame (both image and optical flow frames) of the clip is passed through the learning network 401, in which the learned model 402 is applied to each frame to generate a predicted score. Then, a final score for each surgical clip is obtained from averaging the predicted scores across all or a majority of image frames in the clip. This calculation applies in both training mode and assessing mode. In the training mode 101 (in FIG. 1), this predicted score for each clip is compared with the received assessment score from the surgeon who has viewed the clip, to optimize the learned model. In the assessing mode 100 (in FIG. 1), this predicted score for each clip is outputted as the assessment score for each surgical action.

Additionally and/or alternatively, each of the streams (e.g. the spatial stream net and the temporal stream net, as shown in FIG. 3) are trained separately, each producing a result that can be combined to generate a final decision 210 via feature or score fusion 209. For example, the system may combine two scores from the two streams based on a pre-determined weight. The final result is expected to improve if both modalities capture mutually exclusive information.

As would be apparent to one ordinarily skilled in the art, variations of aforementioned disclosure could be used. For example, a finer-grained scale classification instead of binary classification could be used. Another example of variations includes the value of L, i.e. the number of consecutive optical frames stacked, which can vary from 1 to a larger number depending, among other factors, at least on the size of training dataset. If only a small training dataset is available, then using a larger value of L may worsened the performance. Still further, the background in surgical videos is substantially different from natural scene images in that appearance remains more or less unchanged throughout videos, whereas the motion of robotic arm may contain most of the discriminative information about good or bad quality. This intuition leads to variations of weights between the temporal stream and the spatial stream of the network.

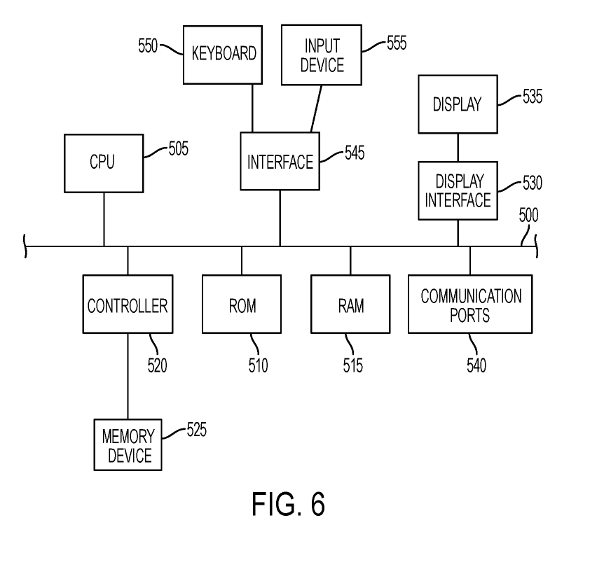

FIG. 6 depicts an example of internal hardware that may be included in any of the electronic components of the system, the user electronic device or another device in the system. An electrical bus 500 serves as an information highway interconnecting the other illustrated components of the hardware. Processor 505 is a central processing device of the system, configured to perform calculations and logic operations required to execute programming instructions. As used in this document and in the claims, the terms “processor” and “processing device” may refer to a single processor or any number of processors in a set of processors, whether a central processing unit (CPU) or a graphics processing unit (GPU) or a combination of the two. Read only memory (ROM), random access memory (RAM), flash memory, hard drives and other devices capable of storing electronic data constitute examples of memory devices 525. A memory device may include a single device or a collection of devices across which data and/or instructions are stored.

An optional display interface 530 may permit information from the bus 500 to be displayed on a display device 535 in visual, graphic or alphanumeric format. An audio interface and audio output (such as a speaker) also may be provided. Communication with external devices may occur using various communication devices 540 such as a transmitter and/or receiver, antenna, an RFID tag and/or short-range or near-field communication circuitry. A communication device 540 may be attached to a communications network, such as the Internet, a local area network or a cellular telephone data network.

The hardware may also include a user interface sensor 545 that allows for receipt of data from input devices 550 such as a keyboard, a mouse, a joystick, a touchscreen, a remote control, a pointing device, a video input device and/or an audio input device. Digital image frames also may be received from an imaging capturing device 555 such as a video or camera positioned over a surgery table or as a component of a surgical device. For example, the imaging capturing device may include imaging sensors installed on a robotic surgical system. A positional sensor and motion sensor may be included as input of the system to detect position and movement of the device.

In implementing the training on the aforementioned hardware, in one embodiment, the entire training data may be stored in multiple batches on a computer readable medium. Training data could be loaded one disk batch at a time, to the GPU via the RAM. Once a disk batch gets loaded onto the RAM, every mini-batch needed for SGD is loaded from RAM to GPU and this process repeats. After all the samples within one disk-batch are covered, the next disk batch is loaded onto the RAM and this process repeats. Since loading data each time from disk to RAM is time consuming, in one embodiment, multi-threading can be implemented for optimizing the network. While one thread loads a data batch, the other trains the network on the previously loaded batch. In addition, at any given point in time, there is at most one training and loading thread, since otherwise multiple loading threads will clog the memory.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of processing a sequence of digital images to automatically assess quality of a surgical procedure, comprising:
by an imaging device, capturing a sequence of digital image frames of a first surgical procedure;
by a processing device, saving one or more clips of the sequence of digital image frames to a data storage facility, each clip comprising a plurality of consecutive digital image frames; and
by a processing device, executing processor readable instructions that are configured to cause the processing device to:
for each clip, perform a dual-stream processing of the image frames in each clip so that the processing device:
identifies a first image stream representing a measure of appearance variation among the image frames in the clip,
identifies a second image stream representing a measure of motion that appears in the image frames of the clip,
processes the first and second image streams with a learned model for surgical quality assessment to automatically generate an assessment score indicative of quality of the surgical procedure in each clip, and
outputs the assessment score for each clip.

2. The method of claim 1, further comprising training the learned model by:
receiving, from an imaging device, an additional sequence of digital image frames of a second surgical procedure, wherein the second surgical procedure is of the same type as the first surgical procedure; and
by a processing device, executing processor readable instructions that are configured to cause the processing device to:
segment the additional sequence of digital image frames into one or more training clips, so that each training clip corresponds to a surgical action and comprises a plurality of consecutive digital image frames,
for each training clip:
receive an assessment score representing a quality of the surgical action of the clip,
perform dual-stream processing of the images in each training clip so that the processing device will train the learned model for surgical quality assessment by:
identifying a first training image stream representing a measure of appearance variation among the image frames in the training clip,
identifying a second training image stream representing a measure of motion that appears in the images frames of the training clip, and
using the first and the second training image streams to automatically learn features needed to train the learned model for surgical quality assessment, and
save the learned model for surgical quality assessment to a computer-readable medium for use in assessing quality of surgical procedure.

3. The method of claim 2, further comprising, by the processing device, further training the learned model by:
receiving a plurality of additional sequences of digital image frames for additional surgical procedures, each of which is of a same type as the first surgical procedure;
segmenting each of the additional sequences into one or more additional clips, so that each additional clip corresponds to a surgical action;
for each additional clip, performing the dual-stream processing of the images in each additional clip so that the processing device will further train the learned model; and
saving the further-trained model to a computer-readable medium for use in assessing quality of surgical procedure.

4. The method of claim 1, wherein the learned model is a convolutional neural network.

5. The method of 1, further comprising, by the processing device, further segmenting the sequence of digital image frames into the one or more clips so that each clip corresponds to a surgical action.

6. The method of claim 1, wherein the sequence of image frames comprises a plurality of channels, each channel representing a primary color in a color space model.

7. The method of claim 6, wherein the color space model is RGB, HSV or CIELAB.

8. The method of claim 1, wherein identifying the first image stream representing the measure of appearance variation among the image frames in the clip comprises:
processing each image frame in the clip, wherein the processing comprises random sub-cropping and random flipping, wherein the random flipping is horizontal or vertical;
forming the processed image frames in the same sequence as their original image frames in the clip to generate the first image stream.

9. The method of claim 1, wherein identifying the second image stream representing the measure of motion that appears in the image frames of the clip comprises:
for each image frame in the clip:
generating an optical flow image frame representing the motion that appears in the image frame,
processing each optical flow image frame, wherein the processing comprises random sub-cropping and random flipping;
forming the processed optical flow image frames in the same sequence as their original image frames in the clip to generate the second image stream.

10. The method of claim 1, wherein the learned model comprises a learned spatial stream net and a learned temporal stream net, and wherein processing the first and second image streams with the learned model to generate an assessment score comprises:
processing the first image stream with the learned spatial stream net to generate a first assessment score;
processing the second image stream with the learned temporal stream net to generate a second assessment score;
combining the first and second assessment scores to generate the assessment score for each clip.

11. The method of claim 10, wherein combining the first and second assessment scores to generate the assessment score for each clip is a weighted combination based on a pre-determined weight.

12. The method of claim 1, further comprising, by the processing device,
averaging the scores of each of the clips of the sequence of image frames of the first surgical procedure to generate an average score;
outputting the average score as a quality assessment score of the first surgical procedure.

13. The method of claim 1, further comprising, by the processing device, before the dual-stream processing is performed, sub-sampling the sequence of image frames for the one or more clips such that the number of image frames contained in each clip is reduced.

14. The method of claim 2, wherein the sequence of image frames comprises a plurality of channels, each channel representing a primary color in a color space model.

15. The method of claim 14, wherein the color space model is RGB, HSV or CIELAB.

16. The method of claim 2, wherein identifying the first training image stream representing the measure of appearance variation among the image frames in the training clip comprises:
processing each image frame in the training clip, wherein the processing comprises random sub-cropping and random flipping;
forming the processed image frames in the same sequence as their original image frames in the training clip to generate the first training image stream.

17. The method of claim 16, wherein identifying the first training image stream representing the measure of appearance variation among the image frames in the training clip further comprises, before processing each image frame in the training clip, pre-processing each image frame by:
computing a mean image of at least a majority of the digital image frames in each training clip; and
subtracting each image frame in the training clip by the mean image.

18. The method of claim 2, wherein identifying the second training image stream representing the measure of motion that appears in the image frames of the training clip comprises:
for each image frame in the training clip:
generating an optical flow image frame representing the motion that appears in the image frame, and
processing each optical flow image frame, wherein the processing comprises random sub-cropping and random flipping; and
forming the processed optical flow image frames in the same sequence as their original image frames in the training clip to generate the second training image stream.

19. The method of claim 2, wherein the learned model comprises a learned spatial stream net and a learned temporal stream net, and wherein training the learned model for surgical quality assessment comprises:
using the first training image stream to train the learned spatial stream net; and
using the second training image stream to train the temporal stream net.

20. The method of claim 2, wherein training the learned model comprises optimizing the learned model with each of the training clips, the optimizing comprises:
for each training clip:
inputting the first and second training image streams to the learned model to generate a predicted assessment score of the training clip, and
optimizing the learned model based on the received assessment score of the training clip and the predicted assessment score of the training clip.

21. The method of claim 20, wherein optimizing the learned model uses stochastic gradient descent having a pre-determined batch size and a momentum.

22. The method of claim 20, wherein optimizing the learned model uses an evaluation metric for measuring cost of training, wherein the evaluation metric is based on a regression framework or rank correlation.

23. The method of claim 4, wherein the convolutional neural network comprises:
a plurality of convolutional layers, each having a pre-determined number of filters of a pre-determined size; and
one or more fully connected layers, each having a pre-determined number of units.

24. The method of claim 23, wherein the convolutional neural network comprises an activation function, wherein the activation function is Rectified Linear Units (ReLU) or tanh.

25. The method of claim 23, wherein the convolutional neural network comprises a pooling layer, wherein the pooling layer functions as softmax for all of the plurality of convolutional layers and the one or more fully connected layers.

26. The method of claim 2, further comprising, before training the learned model, pre-training the learned model by:
receiving a sequence of digital image frames of an action recognition dataset;
pre-training the learned model with the action recognition dataset to generate initial parameters for the learned model.

27. A system of assessing quality of a surgical procedure, comprising:
an imaging device capturing a sequence of digital image frames of a first surgical procedure;
a processing device; and
a non-transitory computer readable medium in communication with the processing device, the computer readable medium comprising one or more programming instructions for causing the processing device to:
save one or more clips of the sequence of digital image frames to a data storage facility, each clip comprising a plurality of consecutive digital image frames, and
for each clip, perform a dual-stream processing of the image frames in each clip so that the processing device:
identifies a first image stream representing a measure of appearance variation among the image frames in the clip,
identifies a second image stream representing a measure of motion that appears in the image frames of the clip,
processes the first and second image streams with a learned model for surgical quality assessment to automatically generate an assessment score indicative of quality of the surgical procedure in each clip, and
outputs the assessment score for each clip.

28. The system of claim 27, wherein the one or more instructions further comprise instructions for causing the processing device to:
receive, from an imaging device, an additional sequence of digital image frames of a second surgical procedure, wherein the second surgical procedure is of the same type as the first surgical procedure;
segment the additional sequence of digital image frames into one or more training clips so that each training clip corresponds to a surgical action and comprises a plurality of consecutive digital image frames;
for each training clip:
receive an assessment score representing a quality of the surgical action of the clip;
perform dual-stream processing of the images in each training clip so that the processing device will train the learned model for surgical quality assessment by:
identifying a first training image stream representing a measure of appearance variation among the image frames in the training clip,
identifying a second training image stream representing a measure of motion that appears in the images frames of the training clip, and
using the first and the second training image streams to train the learned model for surgical quality assessment; and
save the learned model for surgical quality assessment to a computer-readable medium for use in assessing quality of surgical procedure.

29. A method of processing a sequence of digital images to automatically assess quality of a surgical procedure, comprising:
by a processing device, receiving one or more clips of a sequence of digital image frames of a first surgical procedure, each clip comprising a plurality of consecutive digital image frames; and
by the processing device, executing processor readable instructions that are configured to cause the processing device to:
for each clip, perform a dual-stream processing of the image frames in each clip so that the processing device:
identifies a first image stream representing a measure of appearance variation among the image frames in the clip,
identifies a second image stream representing a measure of motion that appears in the image frames of the clip,
processes the first and second image streams with a learned model for surgical quality assessment to automatically generate an assessment score indicative of quality of the surgical procedure in each clip, and
outputs the assessment score for each clip.

30. The method of claim 29, further comprising:
receiving, by the processing device, an additional sequence of digital image frames of a second surgical procedure, wherein the second surgical procedure is of the same type as the first surgical procedure; and
by the processing device, executing processor readable instructions that are configured to cause the processing device to:
segment the additional sequence of digital image frames into one or more training clips, so that each training clip corresponds to a surgical action and comprises a plurality of consecutive digital image frames,
for each training clip:
receive an assessment score representing a quality of the surgical action of the clip,
perform dual-stream processing of the images in each training clip so that the processing device will train the learned model for surgical quality assessment by:
identifying a first training image stream representing a measure of appearance variation among the image frames in the training clip,
identifying a second training image stream representing a measure of motion that appears in the images frames of the training clip, and
using the first and the second training image streams to automatically learn features needed to train the learned model for surgical quality assessment, and
save the learned model for surgical quality assessment to a computer-readable medium for use in assessing quality of surgical procedure.
